(19) United States
(12) Patent Application Publication
(10) Pub. No.: US 2014/0223976 A1
(43) Pub. Date: Aug. 14, 2014

(54) RE-KEYABLE CYLINDER LOCK

(71) Applicant: TONG LUNG METAL INDUSTRY CO., LTD., CHIAYI COUNTY (TW)

(72) Inventors: Ming-Shyang CHIOU, Chiayi City (TW); Ju-Lin YANG, Chiayi County (TW); Yu LIN, Chiayi City (TW)

(73) Assignee: TONG LUNG METAL INDUSTRY CO., LTD., CHIAYI COUNTY (TW)

(21) Appl. No.: 14/168,637

(22) Filed: Jan. 30, 2014

(30) Foreign Application Priority Data
Feb. 8, 2013 (TW) 102202885

(51) Int. Cl. E05B 27/00

(52) U.S. Cl. CPC E05B 27/0003
USPC 70/490

(57) ABSTRACT

A re-keyable cylinder lock includes a cylinder housing, a plug, a carrier, a toothed locking bar and a cotter pin. The plug is operable by a right key to rotate with respect to the housing about a longitudinal axis, and the carrier co-rotates with the plug. The locking bar engages the housing when the plug is in a home position where the cylinder lock is locked. The cotter pin is movable transversely, and has a bar-engaging toothed part engaging the locking bar when the carrier is in a normal position and disengaging from the toothed locking bar when the carrier is moved along the axis to a re-keying position, and a housing-engaging part engaging the housing when the plug is in the home position and when the right key is removed from the plug.

### CROSS-REFERENCE TO RELATED APPLICATION

This application claims priority of Taiwanese Application No. 102202885, filed on Feb. 8, 2013.

### BACKGROUND OF THE INVENTION

1. Field of the Invention

The present invention relates to a cylinder lock, more particularly to a re-keyable cylinder lock.

2. Description of the Related Art

Traditionally, when it is necessary to re-key a lock mounted on a door, the lock is detached from the door to disassemble a plug from the lock and to exchange cotter pins of the plug so as to match a new key. After exchange of the cotter pins, the lock is re-assembled and re-installed on the door. However, disassembly and re-assembly of the lock and exchange of the cotter pins require a certain level of skill and knowledge with respect to the construction of the lock, and are usually done by a locksmith or a skilled worker using special tools. The traditional method for re-keying a lock is therefore inconvenient.

It is known in the art to provide a re-keyable cylinder lock assembly that can be re-keyed by directly inserting a new right key into the assembly without disassembling the assembly. For example, U.S. Pat. No. 7,007,528 and U.S. Pat. No. 7,213,429 disclose a re-keyable cylinder lock assembly, which includes a set of cotter pins movable transversely in a plug disposed in a housing and engageable with a right key, and a carrier that carries a set of re-keying toothed elements releasably engaging respective cotter pins and that is movable longitudinally to move and release the re-keying toothed elements from the respective cotter pins before the insertion of a new right key for conducting a re-keying operation, or to re-engage the re-keying toothed elements with the respective cotter pins after the re-keying operation. Each of the cotter pins has a key-engaging part engageable with a right key and a toothed part engageable with the corresponding re-keying toothed element. Neither re-keying toothed element nor cotter pin engages the housing of the plug. U.S. Pat. No. 7,047,778 discloses in FIG. 18 a re-keyable vehicular lock which includes a re-keying toothed element that can engage a cotter pin and a housing of a plug.

### SUMMARY OF THE INVENTION

An object of the invention is to provide a re-keyable cylinder lock with a robust structure that possesses highly efficient burglar-proof effect and that can be re-keyed with a convenient and easy way.

Another object of the invention is to provide a re-keyable cylinder lock with a cotter pin that is able to engage aright key, a housing of a plug, and a toothed locking bar adapted for re-keying the cylinder lock.

According to one aspect of this invention, a re-keyable cylinder lock is operable using aright key, and comprises a cylinder housing defining a longitudinal axis and having a bar-engaging hole, a plug disposed in the cylinder housing, a carrier disposed in the cylinder housing to co-rotate with the plug, a toothed locking bar disposed in the carrier, and a cotter pin disposed in the plug.

The plug is operable by the right key to rotate with respect to the cylinder housing about the longitudinal axis, and to move toward or away from a home position. The carrier is movable relative to the plug along the longitudinal axis from a normal position to a re-keying position when the right key is inserted into the plug. The toothed locking bar engages the bar-engaging hole when the plug is in the home position and when the right key is removed from the plug. The cotter pin is configured to be actuated by the right key to move transversely of the longitudinal axis, and has a key-engaging part, a bar-engaging toothed part and a housing-engaging part. The bar-engaging toothed part engages the toothed locking bar when the carrier is in the normal position, and disengages from the toothed locking bar when the carrier is in the re-keying position. The housing-engaging part engages the cylinder housing when the plug is in the home position and when the right key is removed from the plug.

According to another aspect of this invention, a re-keyable cylinder lock is operable using a right key, and comprises a cylinder housing defining a longitudinal axis and having a plurality bar-engaging holes, a plug disposed in the cylinder housing, a carrier disposed in the cylinder housing to co-rotate with the plug, a plurality of toothed locking bars disposed in the carrier, and first and second cotter pins disposed in the plug.

The plug is operable by the right key to rotate with respect to the cylinder housing about the longitudinal axis and to move toward or away from a home position. The carrier is movable relative to the plug along the longitudinal axis from a normal position to a re-keying position when the right key is inserted into the plug. The toothed locking bars respectively engage the bar-engaging holes when the plug is in the home position and when the right key is removed from the plug. The first cotter pin is configured to be actuated by the right key to move transversely of the longitudinal axis, and has a key-engaging part, a bar-engaging toothed part and a housing-engaging part. The second cotter pin is configured to be actuated by the right key to move transversely of the longitudinal axis, and has a key-engaging part and a bar-engaging toothed part. The bar-engaging toothed parts of the first and second cotter pins respectively engage the toothed locking bars when the carrier is in the normal position and disengaging from the toothed locking bar when the carrier is in the re-keying position. The housing-engaging part of the first cotter pin engages the cylinder housing when the plug is in the home position and when the right key is removed from the plug.

According to yet another aspect of this invention, a re-keyable cylinder lock comprises a cylinder housing defining a longitudinal axis, a plug disposed in the cylinder housing, a carrier, a toothed locking bar disposed in the carrier, and a cotter pin disposed in the plug.

The cylinder housing has a front end, a rear end opposite to the front end, a cylindrical inner surface that is formed between the front and rear ends and that defines a cylindrical hole, a protruding area that protrudes angularly and inwardly from the cylindrical inner surface at the rear end, a shoulder formation formed at one side of the protruding area forwardly of the rear end, and first and second detent grooves extending longitudinally and forwardly from the rear end to a distance distal from the rear end. The first and second detent grooves are spaced apart angularly from each other, and are indented radially in the protruding area and in a portion of the cylindrical inner surface adjacent to the protruding area.

The plug is disposed in the cylindrical hole of the cylinder housing and has a front face formed with a key access opening, a carrier receiving space, and a longitudinal flat face bounding one side of the carrier receiving space.

The carrier is disposed in the carrier receiving space to co-rotate with the plug, and is movable relative to the plug along the longitudinal axis from a normal position to a re-keying position. The carrier has a flat wall confronting with the longitudinal flat face of the plug, a curved wall opposite to the flat wall, and a detent element that is disposed in the carrier and that is biased to project into the first detent groove from the curved wall when the plug is in a home position and when the carrier is in the normal position. The detent element is biased to project into the second detent groove when the plug is rotated away from the home position and when the carrier is in the re-keying position.

The cotter pin is movable transversely of the longitudinal axis. The cotter pin engages the toothed locking bar when the carrier is in the normal position, and disengages from the toothed locking bar when the carrier is in the re-keying position.

The plug further has a tool access opening formed in the front face and adapted to permit access of a tool to push the carrier to move longitudinally and rearwardly from the normal position to the re-keying position.

The carrier further has a stop part disposed at a rear end of the carrier opposite to the tool access opening. The shoulder formation has a forwardly projecting shoulder part proximate to the first detent groove, and a rearwardly indented shoulder part proximate to the second detent groove. The stop part abuts against the forwardly projecting shoulder part to stop a rearward movement of the carrier when the carrier is in the normal position. The stop part abuts against the rearwardly indented shoulder part to stop a rearward movement of the carrier when the carrier is in the re-keying position.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a re-keyable cylinder lock operable using a first right key according to a preferred embodiment of the present invention;

FIG. 2 is an exploded view of the re-keyable cylinder lock;

FIG. 3A is a perspective view of a cylinder housing of the re-keyable cylinder lock;

FIGS. 3B and 3C are longitudinal sectional views of the cylinder housing respectively taken along line B-B and line C-C in FIG. 3A;

FIG. 4A is a perspective view of a plug of the re-keyable cylinder lock;

FIG. 4B is a side view of the plug;

FIG. 5A is a perspective view of a first cotter pin of the re-keyable cylinder lock;

FIGS. 5B and 5C are cross-sectional views of the first cotter pin respectively taken along line B-B and line C-C in FIG. 5A;

FIGS. 6A and 6B are perspective views of a second cotter pin of the re-keyable cylinder lock;

FIG. 7 is a perspective view of a toothed locking bar of the re-keyable cylinder lock;

FIG. 8A is a perspective view of a carrier of the re-keyable cylinder lock;

FIG. 8B is a side view of the carrier;

FIG. 8C is another perspective view of the carrier from a different view angle;

FIG. 9A is a longitudinal sectional view of the re-keyable cylinder lock without insertion of the first right key;

FIGS. 9B and 9C are transverse sectional views of the re-key-able cylinder lock for respectively illustrating the first and second cotter pins where no right key is inserted in the plug;

FIG. 10A is a longitudinal sectional view of the re-keyable cylinder lock with insertion of the first right key into the plug;

FIGS. 10B and 10C are transverse sectional views of the re-key-able cylinder lock for respectively illustrating the first and second cotter pins engaging the first right key;

FIGS. 11A and 11B are transverse sectional views similar respectively to FIGS. 10B and 10C, but showing that the plug has been rotated clockwise by 90° with respect to the cylinder housing;

FIGS. 12A and 12B are perspective transverse sectional views of the re-keyable cylinder lock for respectively illustrating the first and second cotter pins, where the carrier is moved relative to the plug along the longitudinal axis from a normal position to a re-keying position;

FIGS. 13A and 13B are perspective transverse sectional views of the re-keyable cylinder lock respectively illustrating the first and second cotter pins, where the carrier is moved to the re-keying position and the first right key is removed from the plug;

FIG. 14A is a longitudinal sectional view of the re-keyable cylinder lock with insertion of a second right key into the plug;

FIG. 14B is a perspective transverse sectional view of the re-keyable cylinder lock illustrating the first cotter pin engaging the second right key;

FIG. 15A is a longitudinal sectional view of the re-keyable cylinder lock, where the plug has been rotated counterclockwise by 90° from a position shown in FIG. 14A; and

FIGS. 15B and 15C are transverse sectional views of the re-key-able cylinder lock for respectively illustrating the first and second cotter pins after the plug has been rotated counterclockwise by 90°.

### DETAILED DESCRIPTION OF THE PREFERRED EMBODIMENT

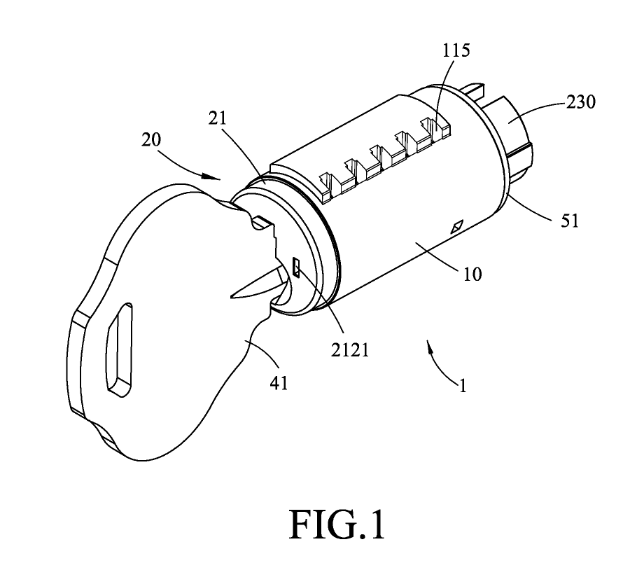

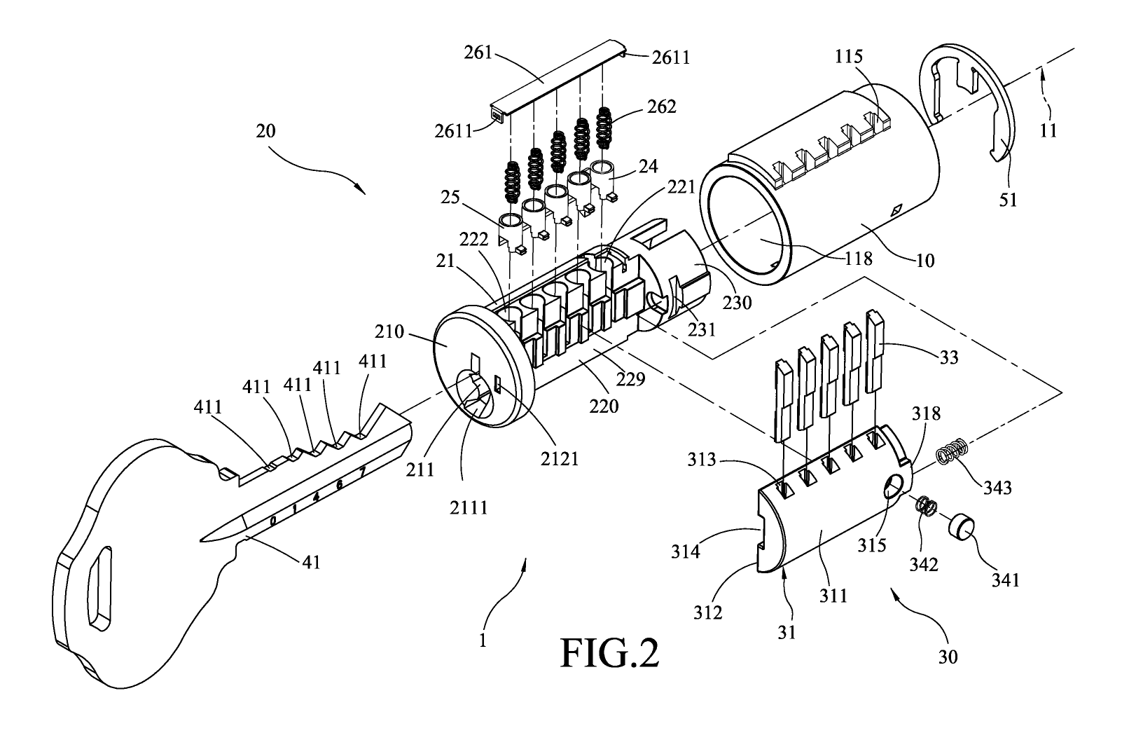

Referring to FIGS. 1 and 2, a re-keyable cylinder lock 1 according to a preferred embodiment of the present invention is shown to include a cylinder housing 10, a plug assembly 20 and a retaining ring 51. The re-keyable cylinder lock 1 is operable using a first right key 41. The first right key 41 has a plurality of cuts 411.

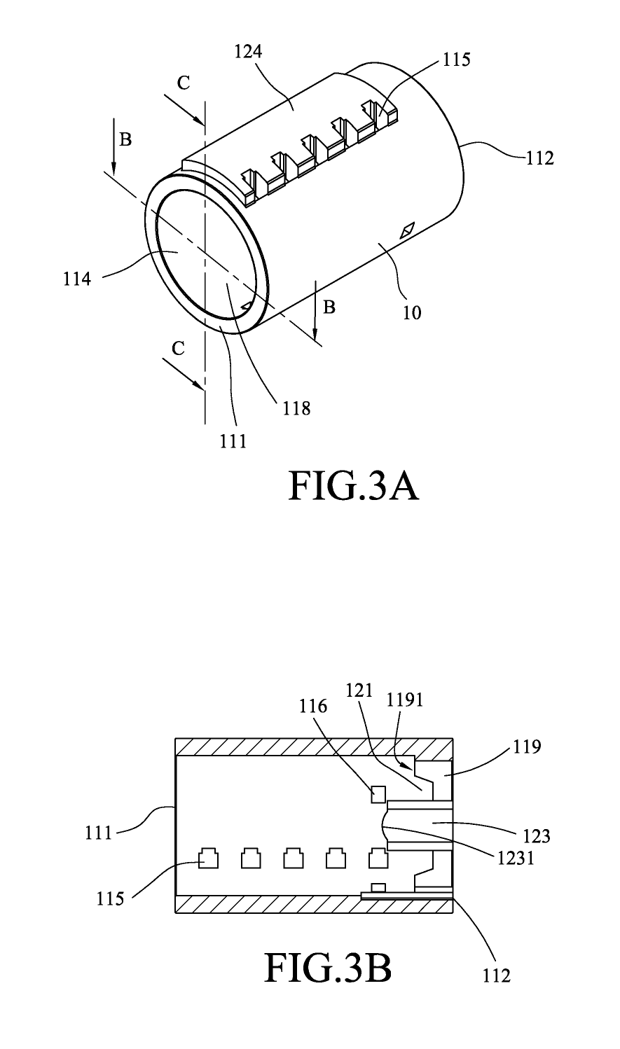

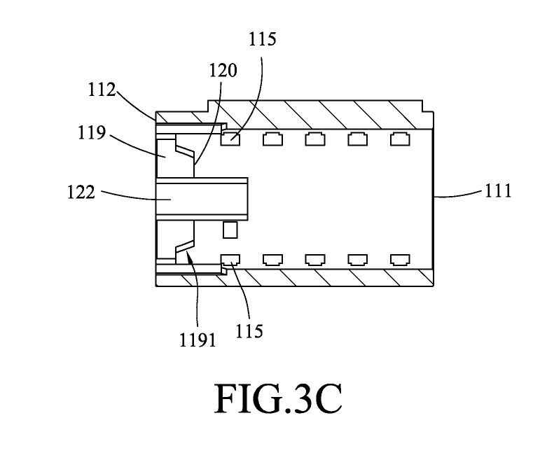

Further referring to FIGS. 3A to 3C, the cylinder housing 10 defines longitudinal axis 11, and has a front end 111, a rear end 112, a cylindrical inner surface 114, a protruding area 119 and a shoulder formation 1191. The cylindrical inner surface 114 is formed between the front end 111 and the rear end 112, and defines a cylindrical hole 118 for the plug assembly 20 to rotate therein. The protruding area 119 protrudes angularly and inwardly from the cylindrical inner surface 114 at the rear end 112. The shoulder formation 1191 is formed at a front side of the protruding area 119 forwardly of the rear end 112.

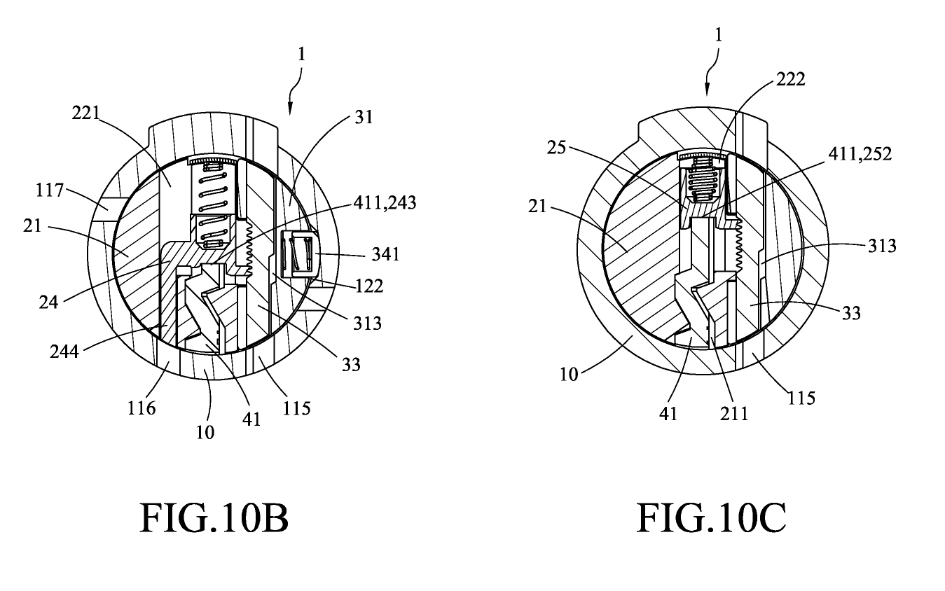

The cylinder housing 10 further has a plurality of bar-engaging holes 115 that are spaced apart from each other along the longitudinal axis 11, first and second detent grooves 122 and 123 that are angularly spaced apart from each other, and first and second pin-engaging holes 116 and 117 that are angularly spaced apart from each other (see FIG. 10B). Each of the first and second detent grooves 122, 123 extends longitudinally and forwardly from the rear end 112 to a distance distal from the rear end 112, and is indented radially in the protruding area 119 and in a portion of the cylindrical inner surface 114 adjacent to the protruding area 119. The first detent groove 122 is longer than the second detent groove 123. The second detent groove 123 has an engaging portion 1231 distal from the rear end 112. The shoulder formation 1191 has a forwardly projecting shoulder part 120 proximate to the first detent groove 122, and a rearwardly indented shoulder part 121 proximate to the second detent groove 123. In this embodiment, the first and second detent grooves 122 and 123 are angularly spaced apart from each other approximately by 90°, and the first and second pin-engaging holes 116 and 117 are angularly spaced apart from each other approximately by 90° also. The cylinder housing 10 further has a mounting block 124 disposed at an outer surface thereof for the installation of the re-keyable cylinder lock 1.

Referring to FIGS. 1, 2, 4A and 4B, the plug assembly 20 is disposed in the cylinder housing 10, and includes a plug 21, a carrier module 30, a plurality of biasing springs 262, a first cotter pin 24, a plurality of second cotter pins 25 and a cover plate 261.

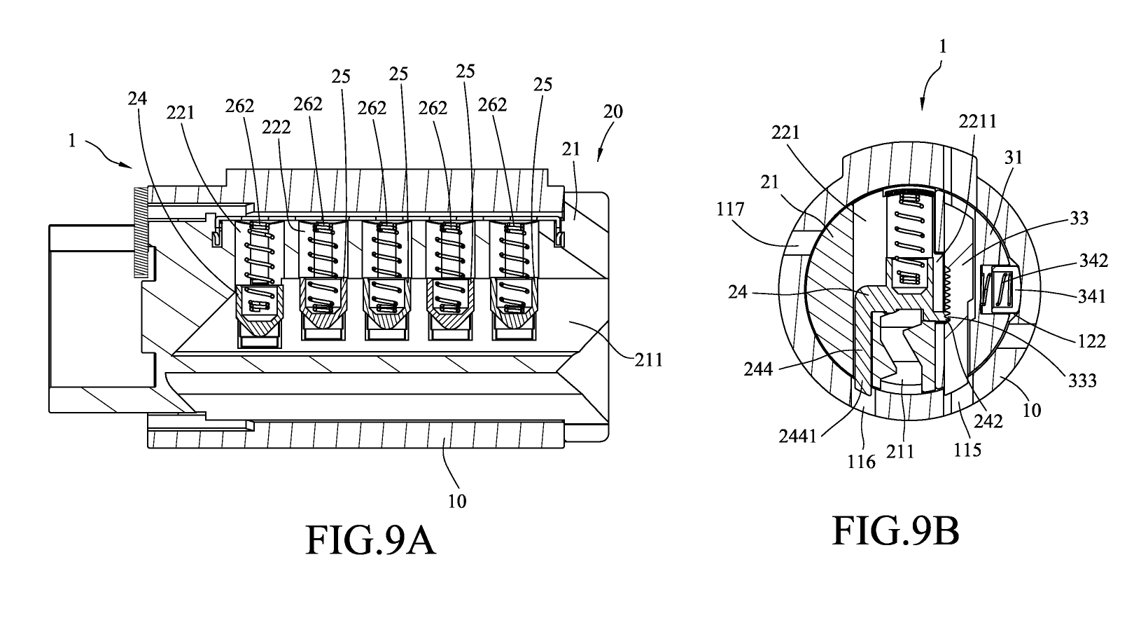

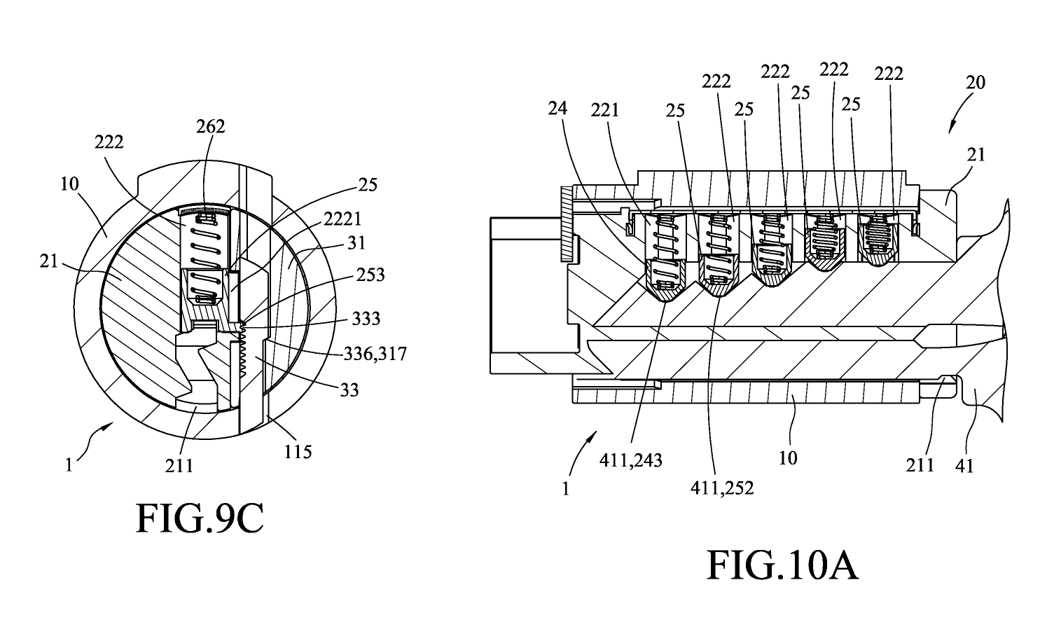

The plug 21 is operable by the first right key 41 to rotate with respect to the cylinder housing 10 about the longitudinal axis 11 and to move toward or away from a home position (see FIG. 9B). The plug 21 has a front face 210 proximal to the front end 111 of the cylinder housing 10 and opposite to the rear end 112 of the cylinder housing 10, a rear end portion 230 opposite to the front face 210, and a middle portion 220 formed between the front face 210 and the rear end portion 230. The front face 210 is formed with a key access opening 2111, and a tool access opening 2121 that is adapted to permit access of a tool for re-keying the re-keyable cylinder lock 1. The plug 21 further has a key hole 211 extending from the key access opening 2111 toward the rear end portion 230. The rear end portion 230 has a peripheral surface formed with a slot 231, and the retaining ring 51 engages the slot 231 so as to retain the plug assembly 20 within the cylinder housing 10. The rear end portion 230 is configured to be connected to and drive a latch (not shown).

The middle portion 220 of the plug 21 has a carrier receiving space 229 that receives the carrier module 30, a longitudinal flat face 224 bounding a longitudinal side of the carrier receiving space 229, and two transverse flat faces 227 (only one can be seen due to the view angle) confronting with each other and bounding respectively two transverse sides of the carrier receiving space 229. One of the transverse flat faces 227 that is proximate to the rear end portion 230 is formed with a notch 2271. The middle portion 220 is formed with a first pin-receiving channel 221 that receives the first cotter pin 24 and one of the biasing springs 262 therein, a first channel opening 2211 that opens at the longitudinal flat face 224 and that spatially communicates with the first pin-receiving channel 221, a plurality of second pin-receiving channels 222 that respectively receive the second cotter pins 25 and the remaining biasing springs 262 therein, and a plurality of second channel opening 2221 that open at the longitudinal flat face 224 and that spatially and respectively communicate with the second pin-receiving channels 222. The first and second pin-receiving channels 221, 222 extend transversely of the longitudinal axis 11 to the key hole 211.

The middle portion 220 of the plug 21 further has a plurality of stepped blocks (A) formed on the longitudinal flat face 224 in proximity to the first and second channel openings 2211, 2221, respectively. Each of the stepped block (A) has a first block portion 225 protruding from the longitudinal flat face 224, and a second block portion 226 protruding from the longitudinal flat face 224 to an extent farther than the first block portion 225.

The middle portion 220 of the plug 21 further has a plate receiving space 223 over the first and second pin-receiving channels 221, 222 and in spatial communication therewith, a top flat face 2231 bounding one side of the plate receiving space 223 and perpendicular to the longitudinal flat face 224, and two engaging slots 2232 formed respectively at opposite front and rear ends of the top flat face 2231. The cover plate 261 is disposed in the plate receiving space 223 for covering the first and second pin-receiving channels 221, 222, and has two engaging protrusions 2611 extending respectively from opposite front and rear edges of the cover plate 261 and respectively engaging the engaging slots 2232.

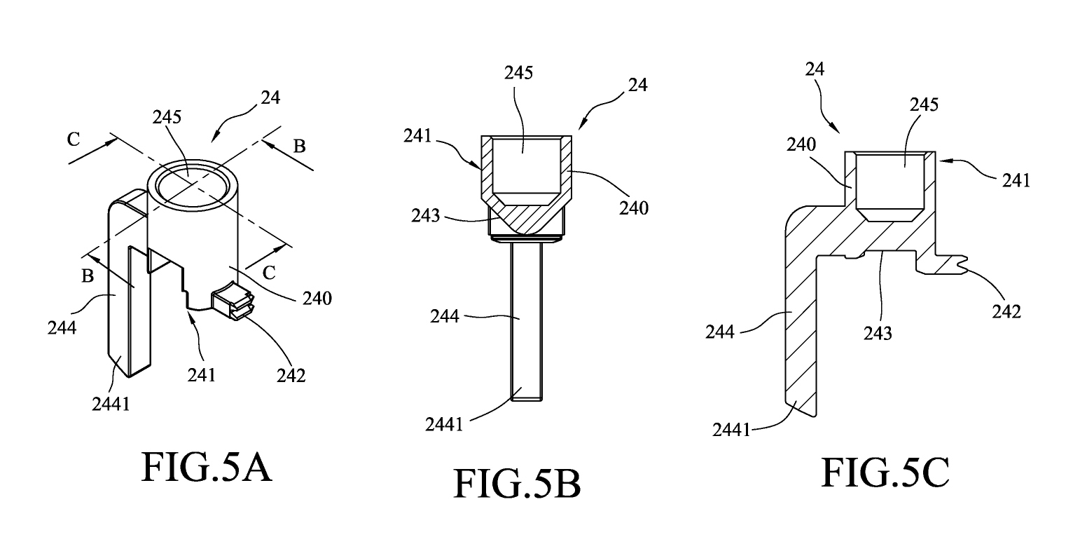

Referring to FIGS. 2 and 5A to 5C, the first cotter pin 24 is disposed in the first pin-receiving channel 221 of the middle portion 220 of the plug 21 transversely of the key hole 211, and is configured to be actuated by the first right key 41 to move transversely of the longitudinal axis 11. The first cotter pin 24 has a key-engaging part 241, a bar-engaging toothed part 242 and a housing-engaging part 244. The bar-engaging toothed part 242 is disposed at one side of the key-engaging part 241, and has two teeth in this embodiment. The housing-engaging part 244 is disposed at the other side of the key-engaging part 241 oppositely of the bar-engaging toothed part 242. The key-engaging part 241 of the first cotter pin 24 includes a cup body 240 that has a spring receiving space 245 receiving the biasing spring 262 therein, and a curved cup bottom end 243 that is opposite to the spring receiving space 245. The curved cup bottom end 243 of the key-engaging part 241 extends into the key hole 211, and is adapted to engage one of the cuts 411 of the first right key 41. The bar-engaging toothed part 242 and the housing-engaging part 244 are respectively connected to two opposite sides of the cup body 240. The housing-engaging part 244 is in the form of a stick that has a free end 2441 to engage the first or second pin-engaging hole 116, 117 in the cylinder housing 10.

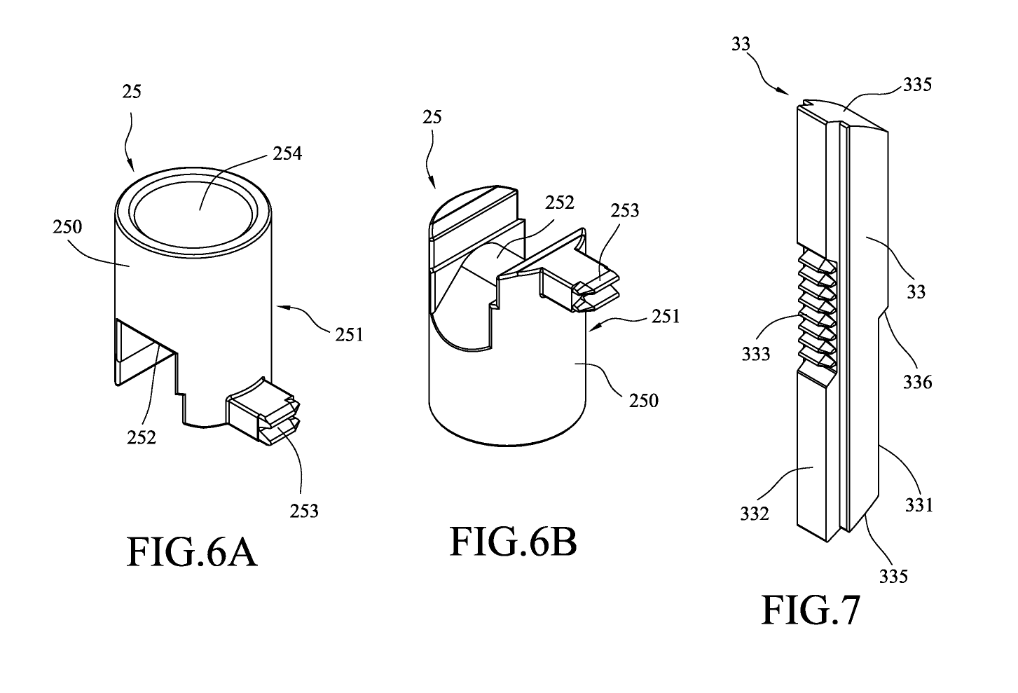

Referring to FIGS. 2, 6A and 6B, the second cotter pins 25 are disposed respectively in the second pin-receiving channels 222 of the middle portion 220 of the plug 21 transversely of the key hole 211, and are configured to be actuated by the first right key 41 to move transversely of the longitudinal axis 11. Each of the second cotter pins 25 has a key-engaging part 251 and a bar-engaging toothed part 253. The bar-engaging toothed part 253 has two teeth in this embodiment. The key-engaging part 251 of the second cotter pin 25 includes a cup body 250 that has a spring receiving space 254 receiving one of the remaining biasing springs 262 therein, and a curved cup bottom end 252 that is opposite to the spring receiving space 254. The curved cup bottom end 252 of the key-engaging part 251 extends into the key hole 211, and is adapted to engage one of the remaining cuts 411 of the first right key 41.

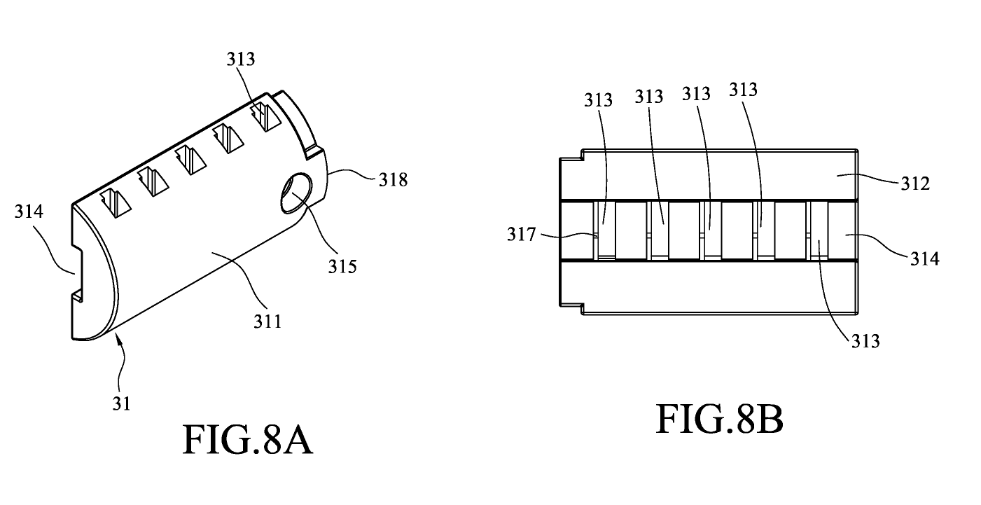

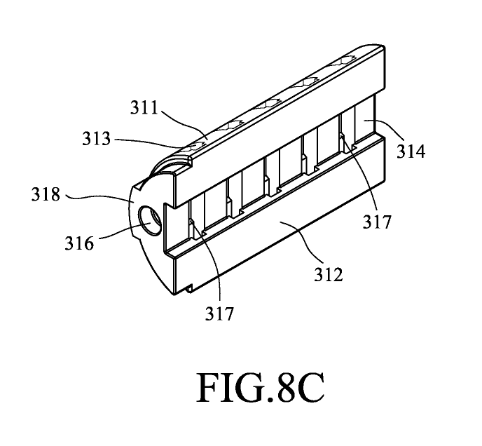

Referring to FIGS. 2, 7 and 8A to 8C, the carrier module 30 includes a carrier 31 and a plurality of toothed locking bars 33 (see FIG. 7). The carrier 31 is disposed in the carrier receiving space 229 in the middle portion 220 of the plug 21 to co-rotate with the plug 21, and is movable relative to the plug 21 along the longitudinal axis 11 from a normal position to a re-keying position. The carrier 31 has a flat wall 312 confronting with the longitudinal flat face 224 of the plug 21, a curved wall 311 opposite to the flat wall 312, and a stop part 318 disposed at a rear end of curved wall 311 opposite to the tool access opening 2121. The carrier 31 further has a plurality of bar-receiving holes 313 formed through the curved wall 311, a recess 314 indented inwardly from the flat wall 312, a detent hole 315 indented inwardly from an outer surface of the curved wall 311 and adjacent to the stop part 318, a plurality of stop protrusions 317 each disposed at one sidewall of one of the bar-receiving holes 313, and a detent element 341 received in the detent hole 315 and loaded with a first spring 342. The recess 314 extends along the longitudinal axis 11, and spatially communicates with the bar-receiving holes 313. The carrier 31 further has a spring receiving hole 316 formed at a distal end thereof that is proximate to the stop part 318 and that confronts with one of the transverse flat faces 227 which is formed with the notch 2271. The carrier 31 is biased by a second spring 343, which is loaded in the notch 2271 and the spring receiving hole 316 for biasing the carrier 31 to move to the normal position.

The toothed locking bars 33 are disposed in the bar-receiving holes 313 of the carrier 31, respectively. Each of the toothed locking bars 33 has a first side surface 331 provided with a stopper 336, a second side surface 332 opposite to the first side surface 331 and formed with a plurality of teeth 333 at the middle thereof, and two opposite distal curved ends 335 with a curve that matches with the outer surface of the curved wall 311.

To assemble the re-keyable cylinder lock 1 of this embodiment, the first and second cotter pins 24, 25 are disposed respectively in the first and second pin-receiving channels 221, 222, and the bar-engaging toothed parts 242, 253 extends respectively out of the first and second channel openings 2211, 2221. The biasing springs 262 are respectively disposed within the spring receiving spaces 245, 254 of the first and second cotter pins 24, 25, and then, the cover plate 261 is disposed into and engages the plate receiving space 223 in the plug 21 so as to keep the biasing springs 262 steady. To assemble the carrier module 30, the toothed locking bars 33 are disposed respectively into the bar-receiving holes 313 in the carrier 31, and the detent element 341 is disposed into the detent hole 315 together with the first sprig 342. Consequently, the first right key 41 is inserted into the key hole 211 in the plug 21, and the carrier module 30 is disposed into the carrier receiving space 229 in the plug 21 with the second spring 343 loaded in the notch 2271 of the plug 21 and the spring receiving hole 316 of the carrier 31. Finally, the plug assembly 20 is slid into the cylindrical hole 118 of the cylinder housing 10 along the longitudinal axis 11, and the retaining ring 51 engages the slot 231 of the plug 21 to retain the plug assembly 20 within the cylinder housing 10.

Referring to FIGS. 9A to 9C, the plug 21 is in the home position and the carrier 31 is in the normal position, where the first and second cotter pins 24, 25 are biased respectively by the biasing springs 262 and are located at respective bottoms of the first and second pin-receiving channels 221, 222, and the toothed locking bars 33 are aligned respectively with the first and second channel openings 2211, 2221 and engage the bar-engaging toothed parts 242, 253 of the first and second cotter pins 24, 25, respectively. In the home position of the plug 21 and the normal position of the carrier 31, the free end 2441 of the housing-engaging part 244 of the first cotter pin 24 engages the first pin-engaging hole 116 of the cylinder housing 10, and the toothed locking bars 33 engage the bar-receiving holes 115 of the cylinder housing 10, such that the plug assembly 20 is prevented from rotating with respect to the cylinder housing 10. Further, in the normal position of the carrier 31, the detent element 341 is biased by the first spring 342 to project into the first detent groove 122 from the curved wall 311, and the stop part 318 of the carrier 31 abuts against the forwardly projecting shoulder part 120 of the shoulder formation 1191 of the cylinder housing 10 to stop a rearward movement of the carrier 31. The stoppers 336 of the toothed locking bars 33 may abut against the respective stop protrusions 317 to stop further downward movement relative to the cylinder housing 10 as shown in FIG. 9C).

Referring to FIGS. 10A to 10C, when the first right key 41 is inserted into the key hole 211, the cuts 411 of the first right key 41 abut against the curved cup bottom ends 243, 252 of the first and second cotter pins 24, 25, respectively, so as to move and raise the first and second cotter pins 24, 25 transversely of the longitudinal axis 11 within the first and second pin-receiving channels 221, 222. Accordingly, the housing-engaging part 244 of the first cotter pin 24 disengages from the first pin-engaging hole 116 of the cylinder housing 10. At the same time, each of the toothed locking bars 33 moves along with a corresponding one of the first and second cotter pins 24, 25, such that the toothed locking bars 33 disengage from the bar-receiving holes 115 of the cylinder housing 10 and completely retract in the bar-receiving holes 313 of the carrier 31. As a result, the plug assembly 20 is operable by the first right key 41 to rotate respect to the cylinder housing 10.

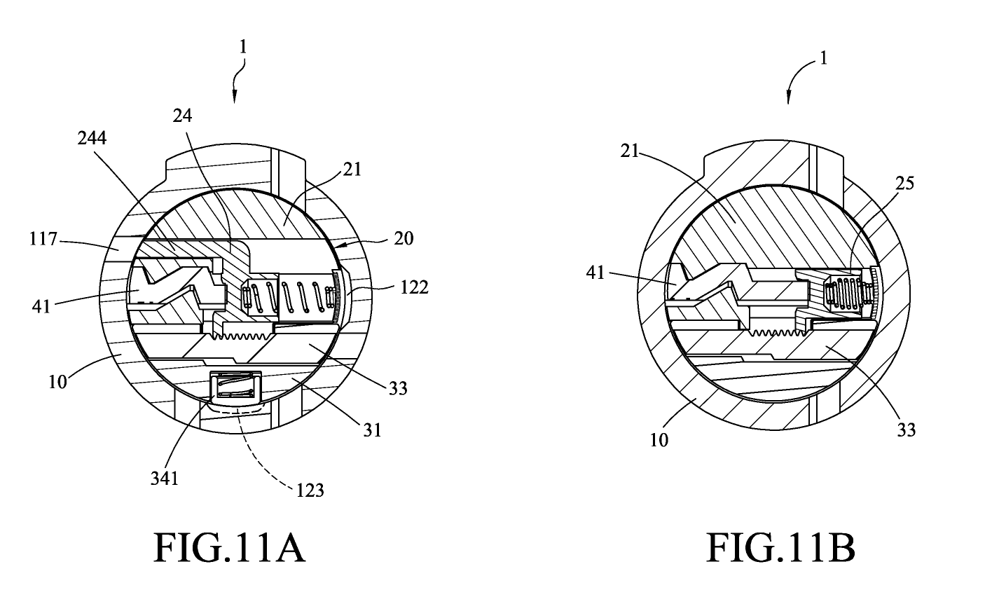

Referring to FIGS. 11A and 11B, when the plug assembly 20 is rotated clockwise by 90° with respect to the cylinder housing 10 (i.e., the plug 21 moves away from the home position as shown in FIGS. 9A to 9C), the detent element 341 of the carrier 31 moves away from the first detent groove 122 to a position aligned with the second detent groove 123, and the stop part 318 of the carrier 31 deviates from the forwardly projecting shoulder part 120 of the cylinder housing 10 and is aligned with the rearwardly indented shoulder part 121 of the cylinder housing 10 (see FIGS. 2, 3A to 3C and 8A to 8C). Since the first detent groove 122 is longer than the second detent groove 123, the detent element 341 does not project into the second detent groove 123 in this state. Further, the housing-engaging part 244 of the first cotter pin 24 is aligned with the second pin-engaging hole 117 of the cylinder housing 10.

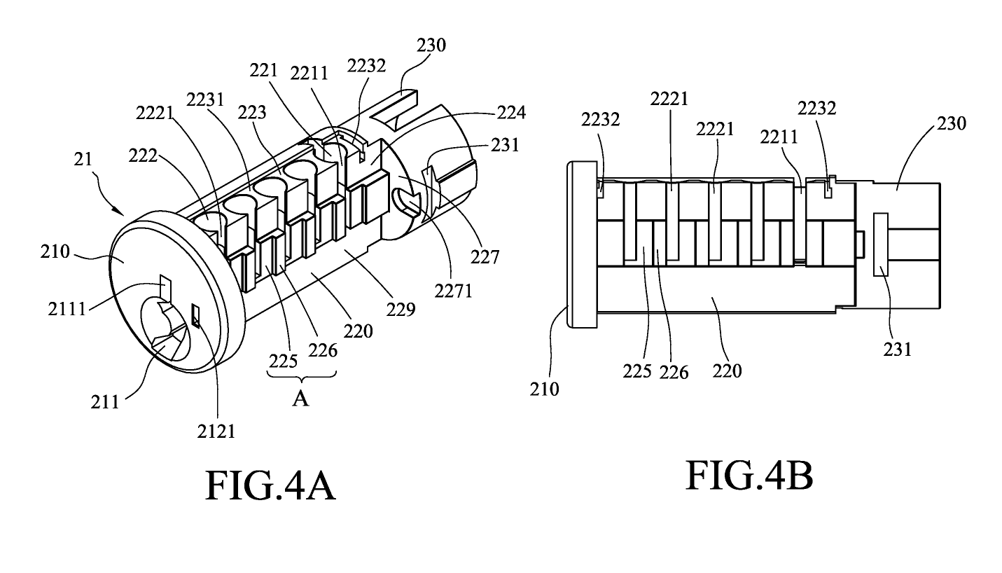

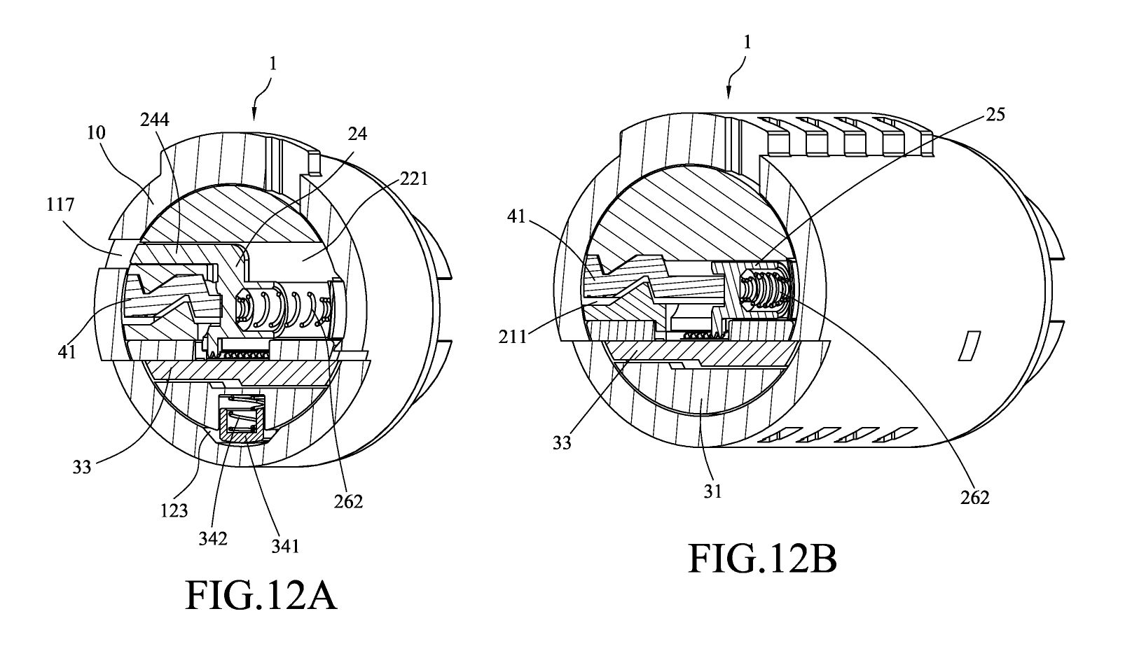

For re-keying the re-keyable cylinder lock 1 with another key, a tool (not shown) is inserted into the tool access opening 2121 of the plug 21 so as to push the carrier 31 to move longitudinally and rearwardly from the normal position to the re-keying position as shown in FIGS. 12A and 12B. In the re-keying position, the detent element 341 is biased by the first spring 342 to project into the second detent groove 123, and engages the engaging portion 1231 of the second detent groove 123 (see FIG. 3B), preventing the carrier 31 from moving back to the normal position by a biasing force of the second spring 343. The stop part 318 of the carrier 31 abuts against the rearwardly indented shoulder part 121 of the cylinder housing 10 to stop the rearward movement of the carrier 31. Further, each toothed locking bar 33 is moved rearwardly and longitudinally to disengage from the bar-engaging toothed part 242, 253 of the corresponding one of the first and second cotter pins 24, 25 and to lie over the first block portion 225 of the plug 21 and to abut against the second block portion 226. The second block portion 226 of the plug 21 blocks the toothed locking bar 33 from moving rearwardly from the first block portion 225 (see FIGS. 4A and 4B).

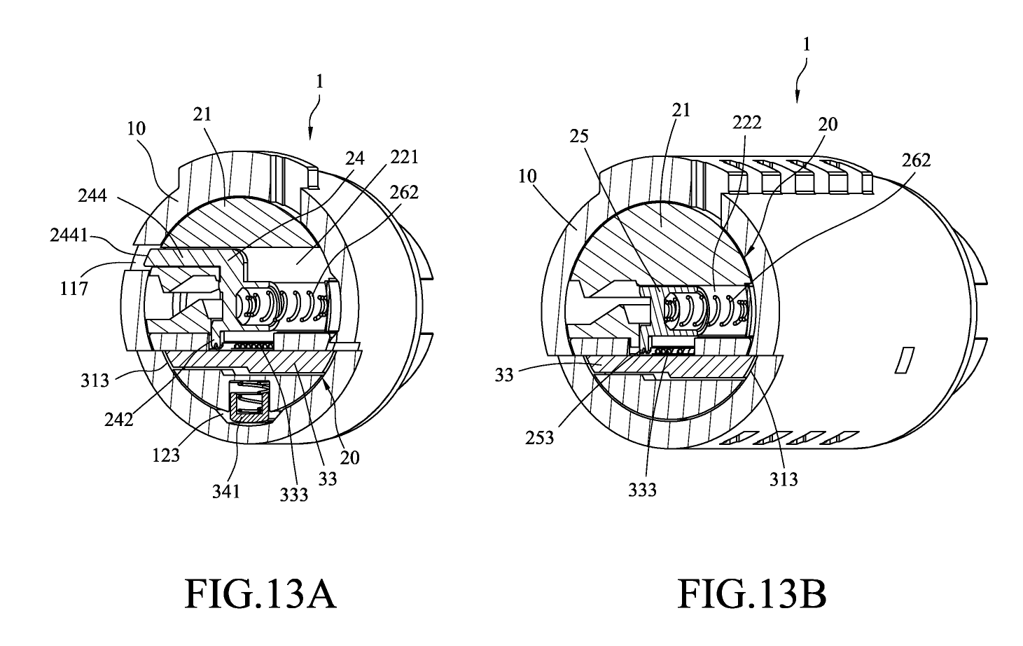

Referring to FIGS. 13A and 13B, when the first right key 41 is removed from the plug 21, the first and second cotter pins 24, 25 are moved respectively by the biasing springs 262 to the respective bottoms of the first and second pin-receiving channels 221, 222. Further, the free end 2441 of the housing-engaging part 244 of the first cotter pin 24 engages the second pin-engaging hole 117 of the cylinder housing 10, preventing unexpected rotation of the plug assembly 20 before a second right key is inserted into the plug 21, which can result in a breakdown of the re-keyable cylinder lock 1. Since the toothed locking bars 33 disengage from the first and second cotter pins 24, 25, they do not extend into the bar-receiving holes 115 of the cylinder housing 10 after the first right key 41 is removed.

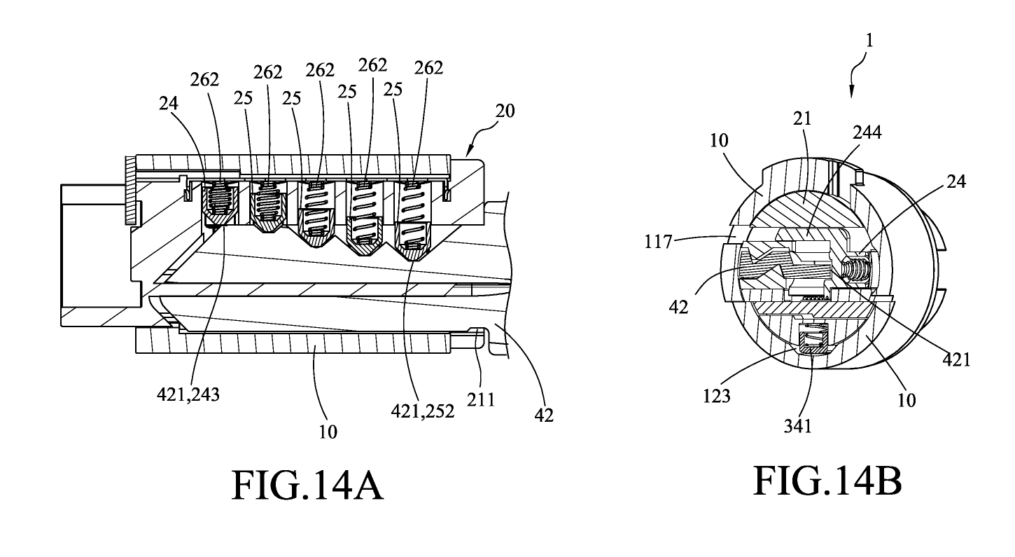

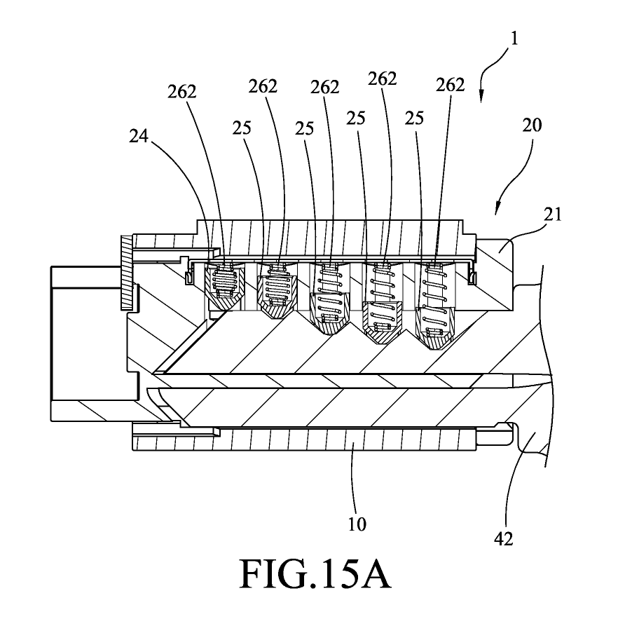

Referring to FIGS. 14A and 14B, when it is intended to re-key the re-keyable cylinder lock 1 with a second right key 42, the second right key 42 is inserted into the key hole 211, and cuts 421 of the second right key 42 abut against the curved cup bottom ends 243, 252 of the first and second cotter pins 24, 25, respectively. As a result, each of the first and second cotter pins 24, 25 is raised to a level which is different that raised by the first key 41, thereby re-orienting the first and second cotter pins 24, 25. In addition, because the housing-engaging part 244 of the first cotter pin 24 disengages from the second pin-engaging hole 117 at this state, the plug assembly 20 is rotatable with respect to the cylinder housing 10.

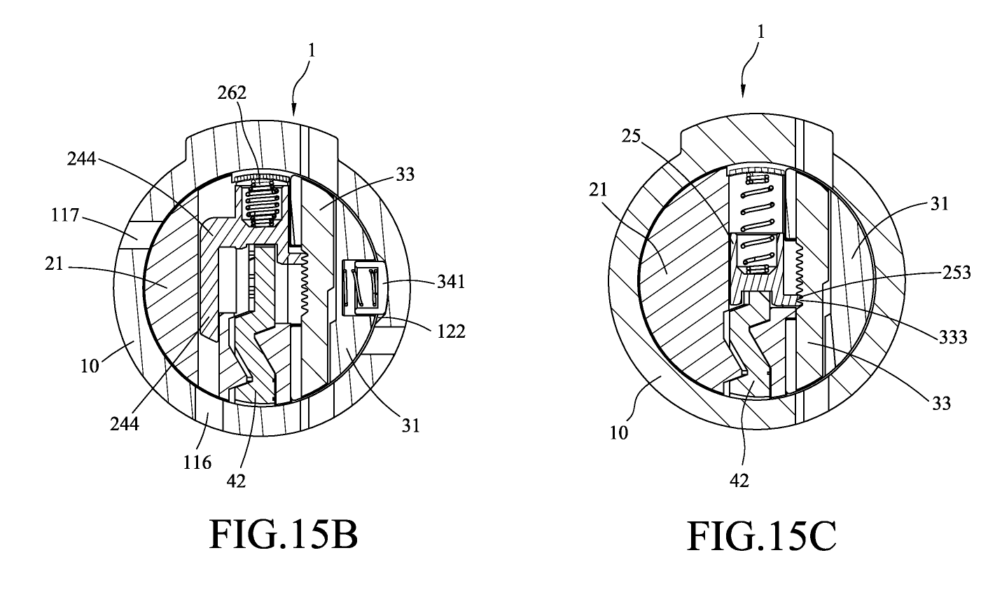

Referring to FIGS. 15A to 15C, the plug 21 is rotated counterclockwise by 90° with respect to the cylinder housing 10, and moves toward the home position. The detent element 341 is thus removed from the second detent groove 123 and disengaged from the engaging portion 1231, such that the carrier 31 is biased by the second spring 343 to move longitudinally back to the normal position. Accordingly, each of the toothed locking bars 33 re-engages the bar-engaging toothed part 242, 253 of the corresponding one of the first and second cotter pins 24, 25, and the detent element 341 is biased to project into the first detent groove 122 since the first detent groove 122 is longer than the second detent groove 123. As a result, the re-keyable cylinder lock 1 is operable using the second right key 42, instead of the first right key 41. It is executable to re-key the re-keyable cylinder lock 1 with yet another key (not shown) according to the foregoing procedure.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A re-keyable cylinder lock operable using a right key, said re-keyable cylinder lock comprising:
a cylinder housing defining a longitudinal axis and having a bar-engaging hole;
a plug disposed in said cylinder housing, and being operable by the right key to rotate with respect to said cylinder housing about the longitudinal axis and to move toward or away from a home position;
a carrier disposed in said cylinder housing to co-rotate with said plug, and being movable relative to said plug along the longitudinal axis from a normal position to a re-keying position when the right key is inserted into said plug;
a toothed locking bar disposed in said carrier to engage said bar-engaging hole when said plug is in the home position and when the right key is removed from said plug; and
a cotter pin disposed in said plug and configured to be actuated by the right key to move transversely of the longitudinal axis, said cotter pin having a key-engaging part, a bar-engaging toothed part and a housing-engaging part;
said bar-engaging toothed part engaging said toothed locking bar when said carrier is in the normal position, and disengaging from said toothed locking bar when said carrier is in the re-keying position;
said housing-engaging part engaging said cylinder housing when said plug is in the home position and when the right key is removed from said plug.

2. The re-keyable cylinder lock as claimed in claim 1, wherein said cylinder housing further has first and second pin-engaging holes that are angularly spaced apart from each other, said housing-engaging part of said cotter pin engages said first pin-engaging hole when said plug is in the home position and when the right key is removed from said plug, and said housing-engaging part engages said second pin-engaging hole when said plug is rotated away from the home position through an operation of the right key, when said carrier is moved to the re-keying position, and when the right key is removed from said plug in the re-keying position of said carrier.

3. The re-keyable cylinder lock as claimed in claim 2, wherein said plug has a key hole, said cotter pin being disposed transversely of said key hole, said key-engaging part extending into said key hole, said bar-engaging toothed part being disposed at one side of said key-engaging part, said housing-engaging part being disposed at the other side of said key-engaging part oppositely of said bar-engaging toothed part.

4. The re-keyable cylinder lock as claimed in claim 3, wherein said key-engaging part of said cotter pin includes a cup body that has a spring receiving space and a biasing spring disposed in said spring receiving space, and a curved cup bottom end adapted to engage the right key, said bar-engaging toothed part and said housing-engaging part being respectively connected to two opposite sides of said cup body, said housing-engaging part being in the form of a stick that has a free end to engage said first or second pin-engaging hole in said cylinder housing.

5. The re-keyable cylinder lock as claimed in claim 2, wherein said plug has a carrier receiving space that receives said carrier, and a longitudinal flat face bounding one side of said carrier receiving space, said carrier having a flat wall confronting with said longitudinal flat face of said plug, a curved wall opposite to said flat wall, a bar-receiving hole that receives said toothed locking bar, a detent hole that is indented inwardly from an outer surface of said curved wall, and a detent element that is received in said detent hole and that is loaded with a spring, said cylinder housing further having angularly spaced apart first and second detent grooves, said detent element being biased to project into said first detent groove when said plug is in the home position and when said carrier is in the normal position, said detent element being biased to project into said second detent groove when said plug is rotated away from the home position and when said carrier is in the re-keying position.

6. The re-keyable cylinder lock as claimed in claim 5, wherein said plug has a front face formed with a key access opening, said cylinder housing further having a front end proximal to said front face of said plug, a rear end opposite to said front end, a cylindrical inner surface that is formed between said front and rear ends and that defines a cylindrical hole for said plug to rotate therein, a protruding area that protrudes angularly and inwardly from said cylindrical inner surface at said rear end, and a shoulder formation formed at one side of said protruding area forwardly of said rear end, each of said first and second detent grooves extending longitudinally and forwardly from said rear end to a distance distal from said rear end and being indented radially in said protruding area and in a portion of said cylindrical inner surface adjacent to said protruding area.

7. The re-keyable cylinder lock as claimed in claim 6, wherein said plug further has a tool access opening formed in said front face and adapted to permit access of a tool to push said carrier to move longitudinally and rearwardly from the normal position to the re-keying position, said carrier further having a stop part disposed at a rear end of said carrier opposite to said tool access opening, said shoulder formation of said cylinder housing having a forwardly projecting shoulder part proximate to said first detent groove, and a rearwardly indented shoulder part proximate to said second detent groove, said stop part abutting against said forwardly projecting shoulder part to stop a rearward movement of said carrier when said carrier is in the normal position, said stop part abutting against said rearwardly indented shoulder part to stop a rearward movement of said carrier when said carrier is in the re-keying position.

8. The re-keyable cylinder lock as claimed in claim 5, wherein said plug further has a pin-receiving channel, a channel opening that opens at said longitudinal flat face of said plug, and a stepped block formed on said longitudinal flat face in proximity to said channel opening, said stepped block having a first block portion protruding from said longitudinal flat face, and a second block portion protruding from said longitudinal flat face to an extent farther than said first block portion, said toothed locking bar being aligned with said channel opening and engaging said cotter pin when said carrier is in the normal position, said toothed locking bar being moved rearwardly and longitudinally to lie over said first block portion and to abut against said second block portion when said carrier is in the re-keying position, said second block portion blocking said toothed locking bar from moving rearwardly from said first block portion.

9. A re-keyable cylinder lock operable using a right key, said re-keyable cylinder lock comprising:
a cylinder housing defining a longitudinal axis and having a plurality bar-engaging holes;
a plug disposed in said cylinder housing, and being operable by the right key to rotate with respect to said cylinder housing about the longitudinal axis and to move toward or away from a home position;
a carrier disposed in said cylinder housing to co-rotate with said plug, and being movable relative to said plug along the longitudinal axis from a normal position to a re-keying position when the right key is inserted into said plug;
a plurality of toothed locking bars disposed in said carrier to respectively engage said bar-engaging holes when said plug is in the home position and when the right key is removed from said plug;
a first cotter pin disposed in said plug and configured to be actuated by the right key to move transversely of the longitudinal axis, said first cotter pin having a key-engaging part, a bar-engaging toothed part and a housing-engaging part; and
a second cotter pin disposed in said plug and configured to be actuated by the right key to move transversely of the longitudinal axis, said second cotter pin having a key-engaging part, and a bar-engaging toothed part;
said bar-engaging toothed parts of said first and second cotter pins respectively engaging said toothed locking bars when said carrier is in the normal position and disengaging from said toothed locking bar when said carrier is in the re-keying position;
said housing-engaging part of said first cotter pin engaging said cylinder housing when said plug is in the home position and when the right key is removed from said plug.

10. The re-keyable cylinder lock as claimed in claim 9, wherein said key-engaging part of said first cotter pin includes a cup body that has a receiving space and a biasing spring disposed in said receiving space, and a curved cup bottom end adapted to engage the right key, said bar-engaging toothed part and said housing-engaging part of said first cotter pin being respectively connected to two opposite sides of said cup body, said housing-engaging part of said first cotter pin being in the form of a stick that has a free end to engage said cylinder housing.

11. The re-keyable cylinder lock as claimed in claim 9, wherein said cylinder housing further has first and second pin-engaging holes that are angularly spaced apart from each other, said housing-engaging part of said first cotter pin engages said first pin-engaging hole when said plug is in the home position and when the right key is removed from said plug, and said housing-engaging part engages said second pin-engaging hole when said plug is rotated away from the home position through an operation of the right key, when said carrier is moved to the re-keying position, and when the right key is removed from said plug in the re-keying position of said carrier.

12. A re-keyable cylinder lock comprising:
a cylinder housing defining a longitudinal axis and having a front end, a rear end opposite to said front end, a cylindrical inner surface that is formed between said front and rear ends and that defines a cylindrical hole, a protruding area that protrudes angularly and inwardly from said cylindrical inner surface at said rear end, a shoulder formation formed at a front side of said protruding area forwardly of said rear end, and first and second detent grooves extending longitudinally and forwardly from said rear end to a distance distal from said rear end, said first and second detent grooves being spaced apart angularly from each other and being indented radially in said protruding area and in a portion of said cylindrical inner surface adjacent to said protruding area;
a plug disposed in said cylindrical hole, and having a front face formed with a key access opening, a carrier receiving space, and a longitudinal flat face bounding one side of said carrier receiving space;
a carrier disposed in said carrier receiving space to co-rotate with said plug, and being movable relative to said plug along the longitudinal axis from a normal position to a re-keying position, said carrier having a flat wall confronting with said longitudinal flat face of said plug, a curved wall opposite to said flat wall, and a detent element that is disposed in said carrier and that is biased to project into said first detent groove from said curved wall when said plug is in a home position and when said carrier is in the normal position, said detent element being biased to project into said second detent groove when said plug is rotated away from the home position and when said carrier is in the re-keying position;
a toothed locking bar disposed in said carrier; and
a cotter pin disposed in said plug to move transversely of the longitudinal axis, said cotter pin engaging said toothed locking bar when said carrier is in the normal position and disengaging from said toothed locking bar when said carrier is in the re-keying position;
wherein said plug further has a tool access opening formed in said front face and adapted to permit access of a tool to push said carrier to move longitudinally and rearwardly from the normal position to the re-keying position;
wherein said carrier further has a stop part disposed at a rear end of said carrier opposite to said tool access opening, said shoulder formation having a forwardly projecting shoulder part proximate to said first detent groove and a rearwardly indented shoulder part proximate to said second detent groove, said stop part abutting against said forwardly projecting shoulder part to stop a rearward movement of said carrier when said carrier is in the normal position, said stop part abutting against said rearwardly indented shoulder part to stop a rearward movement of said carrier when said carrier is in the re-keying position.
